(19) United States
(12) Patent Application Publication
(10) Pub. No.: US 2022/0394430 A1
(43) Pub. Date: Dec. 8, 2022

(54) SYSTEMS AND METHODS FOR IDENTIFYING ENTITY LOCATIONS BASED ON DEVICE LOCATION DATA

(71) Applicant: MASTERCARD INTERNATIONAL INCORPORATED, Purchase, NY (US)

(72) Inventor: Todd Christian Lowenberg, Redding, CT (US)

(21) Appl. No.: 17/732,424

(22) Filed: Apr. 28, 2022

Related U.S. Application Data
(60) Provisional application No. 63/196,886, filed on Jun. 4, 2021.

(51) Int. Cl. H04W 4/029; G06Q 20/40; H04W 4/24

(52) U.S. Cl. CPC H04W 4/029; G06Q 20/4015; H04W 4/24

(57) ABSTRACT

Systems and methods are provided for use in identifying an entity's location based on device-level location data. One example computer-implemented method includes, for an entity associated with an unconfirmed location, transmitting, to a mobile device, a request to identify a physical location of the entity and receiving, from the mobile device, a response including at least (i) an identifier associated with the entity and/or a user associated with the mobile device and (ii) a location of the mobile device at the physical location of the entity. The method also includes matching the location of the mobile device to a transaction record for a transaction at the entity based on the transaction record including the identifier from the response and, in response to a match, assigning the location to the entity and publishing the assigned location of the entity.

### CROSS-REFERENCE TO RELATED APPLICATION

This application claims the benefit of, and priority to, U.S. Provisional Application No. 63/196,886, filed Jun. 4, 2021. The entire disclosure of the above application is incorporated herein by reference.

### FIELD

The present disclosure generally relates to systems and methods for use in identifying locations of entities based on location data for one or more devices (e.g., one or more portable communication devices, such as mobile devices, etc.; one or more other electronic devices; etc.).

### BACKGROUND

This section provides background information related to the present disclosure which is not necessarily prior art.

Entities often offer goods and/or services for sale to users. The goods and/or services may be acquired by the users via transactions through a variety of means, including, for example, transactions to payment accounts, etc. As part of such transactions, via the payment accounts, data is transferred between the entities and other different entities to authorize, settle and/or clear the transactions. In connection therewith, the data is often stored by one or more of the entities, and subsequently, is used for a variety of additional purposes.

### DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in identifying locations associated with entities based on location data from mobile devices associated with users;

FIG. 2 is a block diagram of a computing device, that may be used in the system of FIG. 1; and

FIG. 3 is an example method that may be implemented in connection with the system of FIG. 1 for identifying a location of an entity, based on location data from at least one mobile device.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Users often enter into transactions with merchants (broadly, entities) to purchase desired goods and/or services. In processing the transactions, location data for the merchants, and sometimes, for particular point-of-sale (POS) terminals associated with the merchants (and/or involved in the particular transactions) may be missing or inaccurate. For example, location data, upon which the POS terminals are configured, may include generic corporate addresses for the merchants that are different than actual locations of the transactions, or it may be associated with prior addresses of the POS terminals after being moved or relocated, or it may be inaccurate for other reasons, etc.

Uniquely, the systems and methods herein identify a location of a merchant (again, broadly an entity) (and/or a POS terminal associated with the merchant) based on location data from a mobile device present at the merchant, during a transaction between a user of the mobile device and the merchant. In particular, a location engine computing device is configured to prompt a user with a mobile device to travel to a merchant, with an unconfirmed location. The mobile device is then used to initiate a transaction with the merchant, and to capture a location of the mobile device at the time of the transaction. In connection therewith, the mobile device provides the location of the device to the location engine computing device, which matches the location to a transaction record indicative of the transaction with the merchant. Based on the match, the location engine computing device is then able to assign the location (as received from the mobile device) to the merchant, and publish the assigned location for the merchant as a basis to correct and/or confirm existing location data for the merchant, especially, for use in data processing operations based on the location of the merchant.

In this manner, an alternate route of linking relevant merchant data to device-level location data is established, thereby promoting the accuracy of location identification for certain merchants. As such, by employing certain mobile devices, associated with users already in route to the merchants, efficiency in location identification is layered onto already assigned tasks to thereby provide the benefit of location identification with limited extra task travel for the mobile devices (and associated users). Accurate location data for the merchants may thus be obtained and/or maintained for subsequent use, for example, for providing services related to the merchants, etc.

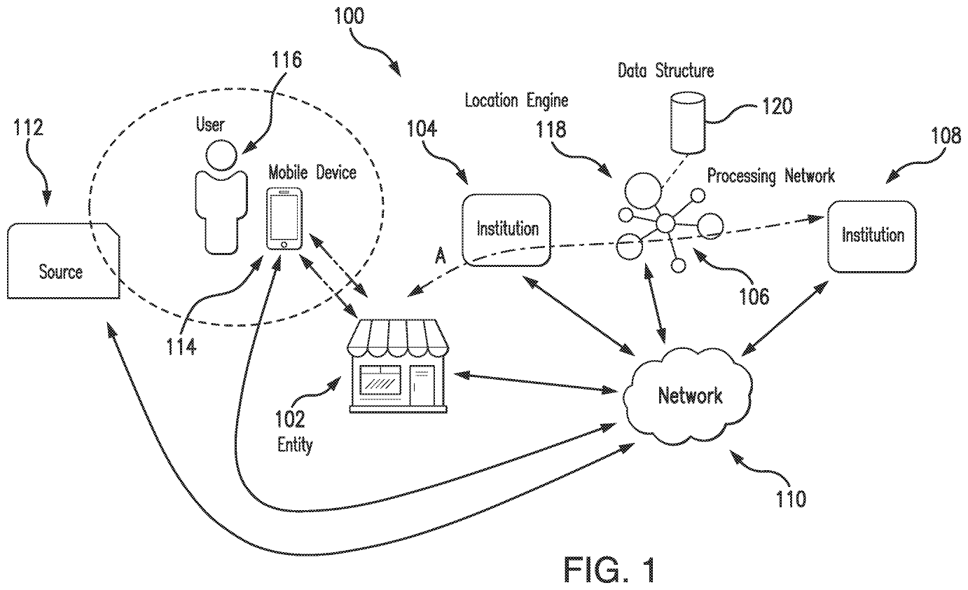

FIG. 1 illustrates an example system 100 in which one or more aspects of the present disclosure may be implemented. Although parts of the system 100 are presented in one arrangement, it should be appreciated that other example embodiments may include the same or different parts arranged otherwise, for example, depending on processing of payment transactions, association of payment account credentials, transmittal of location data, storage of transaction and/or location data, etc.

As shown in FIG. 1, the illustrated system 100 generally includes an entity 102 (e.g., a merchant, etc.), an acquirer institution (or acquirer) 104, a processing network 106, an issuer institution (or issuer) 108, and a source 112, each coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the processing network 106 to the institution 104 and the institution 108 and, separately, a public network through which the processing network 106 may communicate with the source 112 and/or a mobile device 114 associated with a user 116 (e.g., via a web-based application associated with the processing network 106 and installed at the mobile device 114, etc.).

The entity 102 may be any merchant, at which users (e.g., the user 116, etc.) may complete transactions for products (e.g., goods or services, etc.). In the system 100, the entity 102 may include one or more point-of-sale (POS) terminals (not shown), which are configured to interact with the user 116 to authorize transactions, as described below. In various embodiments, each POS terminal is associated with a terminal identifier. It should be appreciated that the entity 102 may include any of a company, an organization, a person, a business, etc., which may be involved in a transaction, etc.

When the user 116 decides to make a purchase, or otherwise initiate a transaction (e.g., conventional transaction for a product, a $0 transaction or balance inquire, etc.), the user 116, or the mobile device 114, provides a payment account credential (e.g., a primary account number (PAN), or token, etc.), for his/her payment account, to the entity 102.

As part of the transaction, then, the entity 102 is configured to compile and transmit an authorization request (e.g., an ISO 8583 message, etc.) to the institution 104. The institution 104 is configured, in turn, to provide the authorization request, along path A, as marked in FIG. 1, to the institution 108, via the processing network 106, such as, for example, through MasterCard®, VISA®, Discover®, American Express®, etc., to determine (by the institution 108) whether the user's payment account is in good standing and whether there is sufficient credit and/or funds to complete the transaction. The institution 108 is configured to then compile and transmit an authorization reply indicating approval/decline (or otherwise) of the transaction back to the institution 104 and the entity 102, thereby permitting the entity 102 to complete the transaction, or to terminate the transaction, or request an alternate form of payment. The transaction, if approved, is later cleared and/or settled by and between the institutions 104 and 108, via the processing network 106.

As such, it should be apparent that the institutions 104 and 108 may include banking or financial institutions, which are coupled to the processing network 106 to provide for transactions, as described herein.

In this example embodiment, the system 100 includes the source 112, which is configured to provide location data associated with the entity 102. In particular, the source 112 may include any entity that includes one or more users (e.g., the user 116, etc.), who possesses a mobile device (e.g., the mobile device 114, etc.) and travels to the entity 102. For example, the source 112 may include a parcel delivery entity (e.g., FedEx®, UPS®, DHL®, etc.), which includes employee users who travel to the locations of various entities in the course of performing parcel delivery services. As another example, the source 112 may include a food/drink delivery service (e.g., Uber Eats®, GrubHub®, DoorDash®, etc.), where the delivery users travel to the locations of various entities in the course of performing food/drink delivery services, etc. Other examples of delivery entities may also be included as (or as part of) the source 112 in other system embodiments. In at least one embodiment, the source 112 may include a specific service related to location verification, or a service configured to add location services as generally described herein. For example, the source 112 may include a social network provider, which permits its users to travel to the locations of various entities for purposes to designating a location as associated with a specific entity, etc.

As shown in FIG. 1, the user 116 is associated with the source 112 (as indicated by the dotted circle). In this manner, the user 116 may be an employee, member, contractor, associate, etc., of the source 112, whether through membership, payment (e.g., salary, fees, etc.), or otherwise.

It should be appreciated that while only one user 116 and one mobile device 114 is shown in FIG. 1, various system embodiments may include multiple users and associated mobile devices (e.g., hundreds, thousands, tens of thousands, or more or less, etc.). Likewise, while only one entity 102 and one source 112 is shown in FIG. 1, other system embodiments may include multiple different entities and/or multiple different sources, etc. It should also be appreciated that a different number of institutions (e.g., acquirers, issuers, etc.), processing network, networks, etc., may be included in other embodiments.

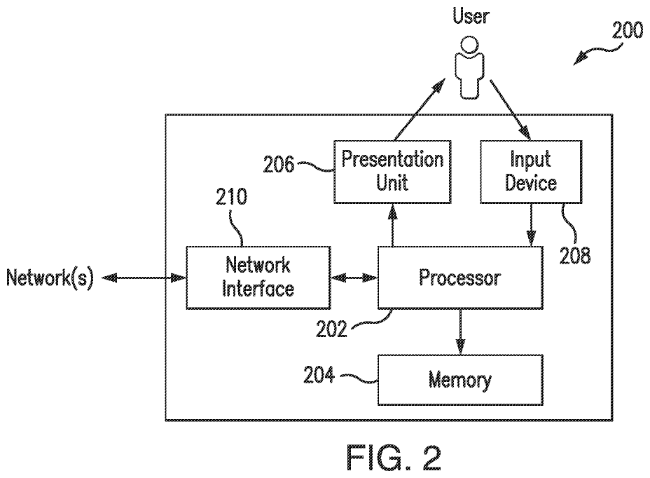

FIG. 2 illustrates example computing device 200, which is suitable for use in the system 100. By way of example (and without limitation), the example computing device 200 may include one or more servers, workstations, personal computers, laptops, tablets, PDAs, telephones (e.g., cellular phones, smartphones, other phones, etc.), combinations thereof, etc., as appropriate. In the system 100 (of FIG. 1), the entity 102, the institutions 104 and 108, the processing network 106, the source 112, and the mobile device 114 are each associated with, or implemented in, a computing device consistent with and/or similar to the computing device 200. With that said, it should be appreciated that the system 100 is not limited to the computing device 200, as different computing devices and/or arrangements of computing devices may be used. It should also be appreciated that different components and/or arrangements of components may be used in other computing devices. Further, in various example embodiments, the computing device 200 may include multiple computing devices located in close proximity, or distributed over a geographic region (such that each computing device 200 in the system 100 may represent multiple computing devices), so long as the computing devices are specifically configured to function as described herein.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are example only, and are not intended to limit in any way the definition and/or meaning of processor.

The memory 204, as described herein, is one or more devices that enable information, such as executable instructions and/or other data, to be stored and retrieved. The memory 204 may include one or more computer-readable storage media, such as, without limitation, dynamic random access memory (DRAM), static random access memory (SRAM), read only memory (ROM), erasable programmable read only memory (EPROM), solid state devices, CD-ROMs, thumb drives, tapes, flash drives, hard disks, and/or any other type of volatile or nonvolatile physical or tangible computer-readable media. The memory 204 may be configured to store, without limitation, location data, transaction records, entity details (e.g., images, etc.), and/or any other types of data discussed herein and/or suitable for use as described herein, etc.

Furthermore, in various embodiments, computer-executable instructions may be stored in the memory 204 for execution by the processor 202 to cause the processor 202 to perform one or more of the functions described herein (e.g., one or more of the operations of method 300, etc.), where the memory 204 is a physical, tangible, and non-transitory computer-readable storage media. Such instructions often improve the efficiencies and/or performance of the processor 202 that is performing one or more of the various operations herein, whereby the instructions effectively transform the computing device 200 into a special purpose device configured to perform the unique and specific operations described herein. It should be appreciated that the memory 204 may include a variety of different memories, each implemented in one or more of the functions or processes described herein.

The illustrated computing device 200 also includes a presentation unit 206 that is coupled to (and in communication with) the processor 202 (however, it should be appreciated that the computing device 200 could include output devices other than the presentation unit 206, etc., in other embodiments). The presentation unit 206 outputs, or presents, to a user of the computing device 200 (e.g., the user 116, etc.) by, for example, displaying, audibilizing, and/or otherwise outputting information and/or data. It should be further appreciated that, in some embodiments, the presentation unit 206 may comprise a display device such that various interfaces (e.g., applications interfaces, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, the presentation unit 206 includes multiple units.

The computing device 200 further includes an input device 208 that receives inputs from the user 116 of the computing device 200. The input device 208 is coupled to (an in communication with) the processor 202 and may include, for example, a keyboard, a pointing device, a mouse, a touch sensitive panel (e.g., a touch pad or a touch screen, etc.), another computing device, and/or an audio input device. Further, in some example embodiments, a touch screen, such as that included in a tablet, a smartphone, or similar device, may behave as both an output device and an input device. In at least one example embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 110. In some example embodiments, the computing device 200 includes the processor 202 and one or more network interfaces incorporated into or with the processor 202. In various embodiments herein, the presentation unit 206, the input device 208, and/or the network interface 210 may include, among other things, a GPS antenna suitable to capture GPS signals for processing by the processor 202 to determine the location of the computing device 200 (e.g., in connection with the consumer's computing device 200, etc.). In addition (or alternatively), in various embodiments herein, the computing device 200 may rely on additional or other network signals, via network interface 210, to determine its location. With that said, it should be appreciated that any suitable operations to determine locations, by processors, based on GPS signals (or other network signals) may be used.

Referring again to FIG. 1, the processing network 106 includes a location engine 118, and further includes and/or is associated with a data structure 120. The location engine 118 may be part of the processing network 106, as shown in FIG. 1, or separate, in whole or in part, therefrom in other embodiments. In addition, the location engine 118 may be a computing device, for example, consistent with computing device 200, etc. The data structure 120 is coupled in communication with the location engine 118, and may be included in the processing network 106 (as indicated by the dotted line) or may be separate, in whole or in part, therefrom. The data structure 120 is configured to store transaction data and location data for use and/or access by the location engine 118, as described herein. In connection therewith, the data structure 120 may include a listing of entities (e.g., merchants, etc.) (including the entity 102), where each of the entities is generally associated with a location (e.g., an unconfirmed location, an entity-provided location, a location configured as described herein, etc.), or not. The data structure 120 may also include various details for the entities, for example, names, images, etc.

In the illustrated embodiment, the location engine 118 is configured to identify a location of the entity 102 (and other entities) based on link(s) between transaction data for the entity 102 processed through the institution 104 and location data provided (or available) from/through the source 112.

In particular, the location engine 118 is configured to identify entities included in the data structure 120, for which location identification is desired. For example, location identification may be desired for entities with no location data or information included in the data structure 120, or with location data only known from entity provided sources and/or POS terminals at the entities, or with stale locations (e.g., location not identified in a prior n months, a prior n years, etc.), etc. In turn, for each entity (or groups of entities) for which location identification is desired, the location engine 118 is configured to transmit a request to the source 112, and more specifically, the mobile device 114, to identify the location of the particular entities (including, in this example, the entity 102).

The request may be specific to one entity (e.g., to the entity 102, etc.), or to multiple entities, etc. For example, the request may include a request to identify a location of a specific XYZ merchant, or each location of the XYZ merchant where the XYZ merchant includes a chain of locations, etc. The request will generally include an identification of the entity and a description of any supplemental data about the entity also desired or needed for capture (as available), beyond location. For example, in connection with a request directed to entity 102, the supplemental data may include an image of the entity 102 (e.g., a building, signage, a branding, etc.), a phone number of the entity 102, a URL for the entity 102, social media links (e.g., Instragram®, Twitter®, Facebook® services, etc.) for the entity 102, or a chain associated with the entity (e.g., specific merchant, chain of merchants, etc.) (e.g., in the form of URL(s), etc.), a barcode or QR code affixed, displayed or visible at the entity's location, a merchant or industry designation for the entity 102, a code or description for the entity 102, a parent company name for the entity 102, etc. In one specific example, the further data may include an image of a menu displayed outside a restaurant entity, etc.

In addition, the request to the source 112, or mobile device 114, may include queries or questions related to the entity 102. For example, one or more queries may relate to the specific categories of products offered at a merchant, which may be indicative of a specific category of the merchant (e.g., series of questions to elicit data indicative of a merchant category code (MCC), etc.). It should be understood that the queries may be otherwise to validate and/or establish other data related to the entity.

In this example embodiment, the mobile device 114 includes a network-based application (e.g., a virtual wallet (e.g., Apple Pay™, MasterPass™, Google Wallet™, PayPass™, etc.), a payment application, a location application, etc.). The mobile device 114, via the application, is provisioned with a credential (e.g., a primary account number (PAN), or token, etc.), in this example. The credential may be enabled for any kind of transaction (e.g., for purchase of any kind of product, etc.), or may be limited to transactions for purposes of locating entities (e.g., limited to $0 or nominal value transaction (e.g., less than $0.50, less than $1, less than $5, etc.), limited by MCC, limited by time of day or day of week, etc.), etc.

In any case, upon receipt of the request from the location engine 118 directed to the entity 102, the mobile device 114 is configured, by the application, to display the request to the user 116 (e.g., directions, instructions, queries/questions, etc.) and to direct the user 116 to a location of the entity 102 (e.g., via a map-based instruction, etc.). In response, the user 116 travels to the entity 102 (whether immediately or in the course of delivering parcels, food, drinks, etc.). Once at the entity 102, the user 116 may use the mobile device 114 to capture and/or to enter the supplemental data (as directed/instructed or based on queries/questions) (e.g., entering via a keypad, taking a picture via a camera feature, etc.). In connection therewith, it should be appreciated that the mobile device 114, as configured by the application, may obscure license plates or faces included in the images, if any. Moreover, the user 116 may further seek to perform a transaction for a nominal amount (or a $0 transaction, etc.) at the entity 102, whereby the mobile device 114, as configured by the application, provides the credential to the entity 102 (e.g., by tapping at a POS terminal, displaying a QR code, etc.). In at least one example, the credential is provided from a payment card (e.g., a credit card, a debit card, etc.), which is, in turn, provided to the entity 102 and also the mobile device 114 at the time of the transaction (as a trigger to capture a location, etc.), or may be provided prior. In addition, the mobile device 114 is configured, by the application, to receive and/or capture certain data from the entity 102 (e.g., a merchant ID, acquirer ID, a transaction amount, etc.).

At the same time, or near in time to the transaction, the mobile device 114, as configured by the application, captures a present location (e.g., via the input device 208 and/or the network interface 210, etc.) (e.g., a latitude and longitude, etc.) and stores the location data (e.g., as GPS coordinates, etc.) along with a date/time of the location being captured. The location data is then associated with the supplemental data captured at the mobile device 114. The mobile device 114 is configured to then transmit the location data, along with the supplemental data (if any) to the location engine 118, which is configured to store the location data in the data structure 120.

It should be appreciated that the transaction may include multiple transactions, each of which may be associated with a captured present location of the mobile device 114, for example, at multiple different POS terminals of the entity 102, whereby each transaction is initiated at a different POS terminal to ensure the transactions include complete data for the entity 102 (e.g., potentially across the different POS terminals (e.g., terminal identifiers, acquirer credentials, etc.), etc.), etc.

Meanwhile, upon receipt of the credential, the entity 102 is configured to initiate authorization of the corresponding transaction as described above. The authorization request generally includes (without limitation) the credential and the amount of the transaction, as well as a merchant ID, a terminal ID, and an acquirer ID, for the entity 102, etc. The authorization request is transmitted, by the entity 102 to the institution 104, in this embodiment, which is configured to provide the authorization request to the processing network 106. It should be appreciated that the authorization request may be provided to the processing network 106 otherwise in other embodiments. The processing network 106 is configured to pass the authorization request to the institution 108 and, also, may be configured to identify the transaction for purposes of entity location (e.g., based on the credential, the transactions amount, etc.) and to pass the authorization request to the location engine 118, which is configured to store the transaction data therefrom (and in particular, the amount, the merchant ID, the acquirer ID, the credential (or part thereof), etc.) in the data structure 120.

The institution 108 is then configured to respond to the authorization request with an authorization reply, which is transmitted back to the entity 102, via the processing network 106 and the institution 104.

Thereafter, or as part thereof, the location engine 118 is configured to access the data structure 120, and specifically, the transaction data and location data therein. The location engine 118 is configured to then match the transaction data, for a transaction, to the location data from the mobile device 114 (e.g., based on the credential, transaction amount, merchant ID, etc.) and to assign the location data to the entity 102 included in the transaction data (e.g., based on a digital link between the location provided by the mobile device 114 and the transaction initiated by the user 116 at the entity 102, etc.). The location engine 118 may be configured to then proliferate the assigned location to data for the specific entity (e.g., based on the merchant ID, the acquirer ID, etc.) to other parts of the processing network 106, or other entities (e.g., the institutions 104 and 108, etc.), etc.

It should be appreciated that the location engine 118 may be configured to repeat the above at one or more intervals, with one or more users and/or sources, to promote accuracy in location data for entities.

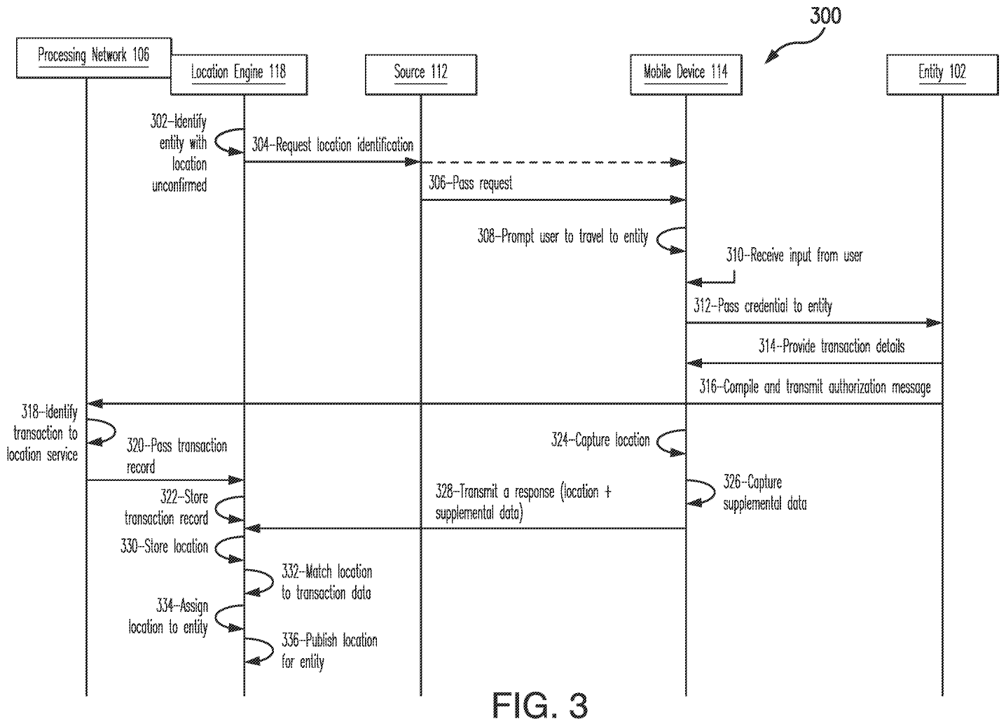

FIG. 3 illustrates example method 300 for use in identifying a location of an entity based on device-level location data. The example method 300 is described as implemented in the location engine 118, the processing network 106 and other parts in the system 100. The method 300, however, could be implemented in one or more other entities or parts of the system 100, or in other embodiments. Further, for purposes of illustration, the example method 300 is described herein with reference to the computing device 200. And, just as the methods herein should not be understood to be limited to the example system 100, or the example computing device 200, the systems and the computing devices herein should not be understood to be limited to the example method 300.

In this example embodiment, it should be understood that the data structure 120 includes one or more entities (e.g., entity 102 which may include a merchant, etc.) having an unconfirmed location. The location may be unconfirmed because the location is known (or provided) from an unreliable or unconfirmed source, or because the location is missing, or potentially, because the location has not been confirmed in a defined interval (e.g., within a last 30 days, within a last three months, within a last six months, within a last year, or more or less, etc.), or because of a change in location of the entity 102, etc. The location engine 118, through method 300, seeks to confirm the location of such entity (and other similar entities) in the data structure 120.

As such, at 302, the location engine 118 identifies an entity in the data structure 120 with a location that is unconfirmed (i.e., entity 102 in this example). Next, at 304, the location engine 118 requests, from the source 112, or the mobile device 114, (directly or indirectly as indicated by the dotted line), a location identification for the entity 102. If the request is received at the source 112, the source 112 (e.g., a source computing device associated with the source 112, etc.) passes the request to the mobile device 114, at 306. In this manner, the source 112 may select the specific mobile device (e.g., the mobile device 114, etc.) scheduled to be within a vicinity of the entity 102 (e.g. an assigned territory, etc.), or already scheduled to be present at the entity 102 (e.g., for purposes of delivery, etc.) and also, potentially, a date range of the travel of the mobile device to the entity 102. In at least one example, the location engine 118 is informed of the planned schedule of the mobile device 114 and other mobile devices and provides requests to specific mobile devices based on that schedule. It is noteworthy that, as noted above, the location engine 118 may communicate directly with the mobile device 114, via an application installed therein (or otherwise), or with the source 112, which in turn, communicates with the mobile device 114, via an application installed therein (or otherwise).

In at least one embodiment, the location engine 118 provides the request in a language suitable to the jurisdiction or region in which the entity 102 is located.

Upon receipt of the request (be it from the location engine 118 directly or via the source 112), the mobile device 114 (as configured by the appropriate application, for example) prompts the user 116 to travel to the entity 102, at 308, either immediately or at a time consistent with an existing schedule of the user 116 (e.g., a delivery schedule, etc.). In doing so, the mobile device 114 may provide directions to the user 116 to travel to the entity 102 (as defined by the unconfirmed location for the entity 102 available to the location engine 118 in the data structure 120).

When the user 116 arrives at the entity 102, the user 116 provides an input to the mobile device 114. The input may simply be an indication of arrival. Or, the input may include an instruction or direction to pass a payment credential to the entity 102, in connection with a transaction (e.g., a $0 transaction, a nominal value transaction, etc.). The input, generally, is an indication from the user 116 related to the arrival of the mobile device 114 at the entity 102. In response, where the input includes the instruction or direction to pass the payment credential, the mobile device 114 receives the input, at 310, and passes the credential to the entity 102, at 312. In this manner, the input may include a tap of the mobile device 114 at a POS terminal of the entity 102, or otherwise. Alternatively, where the provided location is not correct, the input may include an indication that the entity 102 is not at the provided location.

In connection with providing the credential to the entity 102 (e.g., after, prior to, etc.), the entity 102, or more specifically, a POS terminal in this example, provides, at 314, transaction details to the mobile device 114. The transaction details may include a transaction amount, a merchant ID, a terminal ID, an acquirer ID, or other suitable data related to the transaction (and/or the entity 102), etc. Upon receipt of the credential, then, the entity 102 initiates the transaction (based on the proceed transaction details), by compiling and transmitting an authorization message for the transaction to the processing network 106 (e.g., via the institution 104, etc.), at 316. The processing network 106 receives the authorization message and processes the message as is conventional (e.g., directs the authorization message to the institution 108, etc.). In addition in this example, the processing network 106 identifies, at 318, the transaction as related to the location services herein, for example, based on the credential included in the message (e.g., based on the PAN in the authorization message being within a range of primary account numbers (PANs), etc.), or the MCC, or other data potentially specific to the location services herein, etc.). Upon (or in response to) such identification, the processing network 106 passes, at 320, a transaction record for the transaction to the location engine 118. The transaction record may include all, or part, of the data included in the authorization message.

In response to the transaction record (from the processing network 106), the location engine 118 stores, at 322, the transaction record in the data structure 120.

In the meantime, or after, or prior, the mobile device 114 captures its location, at 324 (e.g., a GPS location in latitude and longitude, etc.) (e.g., via the input device 208 and/or the network interface 210, etc.), in connection with the transaction (while at the entity 102). To be clear, the mobile device 114 may capture the location within an interval of passing the credential to the entity 102. The interval may include within 10 seconds, 20 second, one minute, or more or less. The interval may be selected to be short, in order to promote the temporal similarity of the transaction and the location capture, whereby the mobile device 114 may attempt to capture the location at the same time, or substantially the same time, as providing the credential to the entity 102 (e.g., within less than a second, etc.) (i.e., an interval).

In addition to location, the mobile device 114 also captures, at 326 supplemental data for the entity 102. The supplemental data, again, may include an image or multiple images of the entity (e.g., signage, front/back elevation views, features of the entity, etc.), a name of the entity 102, a parent name for entity 102, a street address, contact information (e.g., a phone number, a URL address, etc.), a category of the entity 102, or other suitable data, etc. In connection therewith, the user 116 may be prompted to capture the supplemental data, either via a camera input device of the mobile device, or to enter the data through a keypad or touchscreen input device of the mobile device 114, etc. In general, the supplemental data may be defined in the request from the location engine 118 (at 304), whereby the mobile device 114 prompts the user 116 for the particular supplemental data included in the request.

Thereafter, the mobile device 114 transmits a response, at 328, to the request, back to the location engine 118 (directly or, potentially, via the source 112). The response includes the location captured by the mobile device 114, and the supplemental data. In particular, the response includes an identifier, which may be a merchant ID, an acquirer ID, a terminal ID, or credential of the user 116, whereby the identifier may be specific to the entity 102 and/or the user 116, etc.

Next, at 330, the location engine 118 receives the response and stores the location in the data structure 120, in association with the identifier. The supplemental data may also be stored in the data structure, and associated with either the location or the identifier (or both). In various embodiments, depending on the user 116, it should be appreciated that the location engine 118 (or the processing network 106, more broadly) may respond with coupons, discounts, rewards, or other incentives, to the mobile device 114, either directly (e.g., via the application, etc.), or via the account employed in the transaction (once matched, as described below), etc.

In connection with receipt of the response from the mobile device 114 (or the transaction record from the processing network 106), or at some time later, the location engine 118 matches, at 332, the location (from the mobile device 114) to the transaction record (from the processing network 106) based on the identifier being included in both. For example, where the identifier includes the merchant ID, the response and the transaction record will both have included the merchant ID, as a manner to matching therebetween. The identifier may include multiple identifiers, including, without limitations, ones of the merchant ID, the acquirer ID, the terminal ID, the credential, and even an amount of the transaction, etc. When the match is found, the location engine 118 assigns, at 334, the location of the match to the entity 102 (along with the supplemental data, if any). The assigned location is stored (e.g., a latitude/longitude, or a street address, etc.), along with the supplemental data, if any, in the data structure 120.

And, finally, at 336, the assigned location is published by the location engine 118. The assigned location may be published within the processing network 106, in order to update or confirm data related to the entity 102 and thereby improve the accuracy of services reliant on the data related to the entity 102. What's more, the assigned location may be published to the institution 104 and/or the institution 108, or other entities (e.g., business intelligence entities, public reporting entities, etc.) for services dependent on and/or related to the location of the entity 102, etc.

It should be appreciated that method 300 may be multiplied for various users (e.g., to take advantage of crowdsourcing, etc.), for the same entity (e.g., entity 102 in the above example, etc.), whereby multiple locations will be provided for associated transactions. In connection therewith, prior to assigning the location to the entity 102, the location engine 118 may filter, average and/or aggregate the different locations from the different users to provide still further confidence in the location of the entity 102. For example, where 130 location responses are received by the location engine 118, and matched to corresponding transactions, outliers may be filtered from the location responses (e.g., based on a threshold of 100 feet, or more or less, etc.), and the remaining locations may then be averaged to determine the location of the entity 102. The location engine 118 may then assign that location, at 334. Additionally, or alternatively, statistical analysis may be employed between the different locations from the different mobile devices, and then assigned to the entity 102 only when a sufficient confidence is demonstrated in the aggregate location (e.g., within a defined standard deviation or other threshold, etc.).

In various implementations of the above, the processing network 106 may interact and/or contract with the source 112, where (as described above) the source 112 may include, for example, a delivery service (e.g., a parcel delivery service, a food delivery service, etc.), to perform the location services provided for herein, as a layer on top of the services already being performed by the delivery services (i.e., as services in addition to the delivery services already being performed). In such implementations, drivers or other couriers for the delivery service are users, as described above, with each of the users issued a mobile device (or including an application installed on their mobile device relating to the location services herein). The drivers or other couriers may also be issued accounts specific to the location services (e.g., usable only for $0 transactions, for nominal value transactions, or for transactions limited to particular categories of entities, etc.). The drivers or other couriers may then be assigned particular entities having unconfirmed locations, where the entities coincide with the delivery services being performed by the drivers or other couriers. That is, when a delivery service (specifically, a driver or other courier associated therewith) is tasked with delivering a parcel to an entity, with an unconfirmed location, the location services layer of the delivery service would then apply (in addition to the parcel delivery layer). Consequently, in connection with the delivery of the parcel, the driver or other courier (as the user, as described above), is tasked with initiating a transaction with the entity, and then capturing, if required, supplemental data about the entity. This may be repeated by the delivery service (and the driver or other courier) and/or by other delivery services over a series of days or weeks, for the specific merchant, whereupon the locations from the mobile devices of the different drivers or other couriers are eventually aggregated, as described above.

As also described above, apart from parcel delivery, the delivery services potentially utilized herein (wherein the drivers or other couriers of the delivery services are users as described above) may include food delivery services, whereby drivers or other delivery personnel are the users, who initiate transactions, for example, when picking up food from the entities for delivery to customers or when delivering food to the entities. In connection with such transactions, again, the mobile devices of the users capture locations at the entities as described above.

In various other implementations of the above, the users may be associated with a social network, as the source 112, whereby the processing network 106 may interact and/or contract with the social network to solicit user participation in the location services herein. In doing so, the social network may then assign entities with unconfirmed locations to the users associated with the social network, who volunteer or opt in for participation in such location services (e.g., based on a region specific to the users (e.g., a home region of the users, a region of travel for the users, etc.), etc.). The processing network 106, in connection therewith, may implement a software development kit (SDK) in a social network application installed on the users' mobile devices (to operate consistent with the application described above in the system 100, for example). The processing network 106 may further offer incentives to the users for participation in the location services (e.g., rewards, discounts at participating entities, coupons, etc.). Again, after multiple users provide locations of the respective entities, the location engine 118 may aggregate the locations as described above and then assign the aggregated location to the entity.

What's more, the different locations from the mobile devices may be indicative of different POS terminals within the same entity, whereby the location engine 118 may employ artificial intelligence, clustering and/or other suitable techniques to aggregate the locations for the individual POS terminals (and thereby identify a location for each POS terminal), etc., or conversely, as described above, simply aggregate the location for the single entity, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) identifying an entity associated with an unconfirmed location; (b) transmitting to a mobile device, a request to identify a physical location of the entity, the request including the unconfirmed location of the entity; (c) receiving, from the mobile device, a response to the request, the response including at least (i) an identifier associated with the entity and/or a user associated with the mobile device and (ii) a location of the mobile device at the physical location of the entity; (d) storing, in a data structure, the location of the mobile device in association with the identifier; (e) matching the location to a transaction record for a transaction at the entity based on the transaction record including the identifier from the response, thereby confirming a presence of the mobile device at the physical location of the entity; and (f) in response to a match, assigning the location to the entity and publishing, by the computing device, the assigned location of the entity.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: a processor of a mobile device and a non-transitory memory, which includes executable instruction defining an application, which when executed by the processor, cause the processor to: (a) receive, from a location engine, a request to identify a location of an entity; (b) prompt a user of the mobile device to travel to the entity; (c) pass a credential to the entity, in connection with a transaction with the entity; (d) receive details associated with the transaction; (e) capture a location of the mobile device within an interval of passing the credential to the entity; and (f) transmit a response, to the request, to the location engine, the response including the captured location and an identifier associated with the entity and/or a user associated with the mobile device, thereby permitting the location engine to match the captured response to the transaction and assign the location to the entity.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” as well as the phrase “at least one of” includes any and all combinations of one or more of the associated listed items.

In addition, as used herein, the term product may include a good and/or a service.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in verifying a location associated with an entity, based on device-level data, the method comprising:
identifying, by a computing device, an entity associated with an unconfirmed location;
transmitting, by the computing device, to a mobile device, a request to identify a physical location of the entity, the request including the unconfirmed location of the entity;
receiving, by the computing device, from the mobile device, a response to the request, the response including at least (i) an identifier associated with the entity and/or a user associated with the mobile device and (ii) a location of the mobile device at the physical location of the entity;
storing, by the computing device, in a data structure, the location of the mobile device in association with the identifier;
matching, by the computing device, the location to a transaction record for a transaction at the entity based on the transaction record including the identifier from the response, thereby confirming a presence of the mobile device at the physical location of the entity; and
in response to a match, assigning, by the computing device, the location to the entity and publishing, by the computing device, the assigned location of the entity.

2. The computer-implemented method of claim 1, wherein transmitting the request to the mobile device includes transmitting the request to the mobile device via a source computing device.

3. The computer-implemented method of claim 2, wherein the identifier includes at least one of: a merchant ID associated with the entity, an acquirer ID associated with the entity, and/or an account number for an account associated with the user.

4. The computer-implemented method of claim 1, wherein the response from the mobile device further includes supplemental data associated with the entity; and
wherein assigning the location to the entity further includes assigning the supplemental data from the response to the entity.

5. The computer-implemented method of claim 4, wherein the supplemental data includes at least one of: an image of the entity, a name of the entity, contact information associated with the entity and/or a category of the entity.

6. The computer-implemented method of claim 1, further comprising receiving the transaction record from a processing network computing device; and
storing, by the computing device, the transaction record in the data structure, prior to matching the response to the transaction record.

7. The computer-implemented method of claim 1, wherein the computing device includes a computing device included as part of a processing network.

8. The computer-implemented method of claim 7, wherein publishing the assigned location includes publishing the assigned location within the processing network and an institution associated with the processing network.

9. The computer-implemented method of claim 1, wherein publishing the assigned location includes publishing the assigned location to an institution associated with the entity.

10. A system for use in verifying a location associated with an entity, based on device-level data, the system comprising a computing device configured to:
identify an entity associated with an unconfirmed location;
transmit, to a mobile device, a request to identify a physical location of the entity, the request including the unconfirmed location of the entity;
receive, from the mobile device, a response to the request, the response including at least (i) an identifier associated with the entity and/or a user associated with the mobile device and (ii) a location of the mobile device at the physical location of the entity;
store, in a data structure, the location of the mobile device in association with the identifier;
match the location to a transaction record for a transaction at the entity based on the transaction record including the identifier from the response, thereby confirming a presence of the mobile device at the physical location of the entity; and
in response to a match, assign the location to the entity and publish the assigned location of the entity.

11. The system of claim 10, wherein the computing device includes a payment processing network computing device.

12. The system of claim 10, wherein the request includes one or more queries related to a category of the entity; and
wherein the response from the mobile device further includes supplemental data, which is responsive to the one or more queries and associated with the entity; and
wherein the computing device is further configured to assign the supplemental data from the response to the entity.

13. The system of claim 10, wherein the computing device is configured to publish the assigned location of the entity to an institution associated with the entity.

14. A non-transitory computer readable storage media including executable instructions that, when executed by at least one processor, cause the at least one processor to:
identify an entity associated with an unconfirmed location;
transmit, to a mobile device, a request to identify a physical location of the entity, the request including the unconfirmed location of the entity;
receive, from the mobile device, a response to the request, the response including at least (i) an identifier associated with the entity and/or a user associated with the mobile device and (ii) a location of the mobile device at the physical location of the entity;
store, in a data structure, the location of the mobile device in association with the identifier;
match the location to a transaction record for a transaction at the entity based on the transaction record including the identifier from the response, thereby confirming a presence of the mobile device at the physical location of the entity; and
in response to a match, assign the location to the entity and publish the assigned location of the entity to at least one institution associated with the entity.

15. The non-transitory computer readable storage media of claim 14, wherein the instructions that, when executed by at least one processor, cause the at least one processor to transmit the request to the mobile device via a source computing device.

16. The non-transitory computer readable storage media of claim 14, wherein the identifier includes at least one of: a merchant ID associated with the entity, an acquirer ID associated with the entity, and/or an account number for an account associated with the user.

17. The non-transitory computer readable storage media of claim 14, wherein the response from the mobile device further includes supplemental data associated with the entity; and
wherein the instructions, when executed by the at least one processor, further cause the at least one processor to: assign the supplemental data from the response to the entity.

18. The non-transitory computer readable storage media of claim 17, wherein the supplemental data includes at least one of: an image of the entity, a name of the entity, contact information associated with the entity and/or a category of the entity.

19. The non-transitory computer readable storage media of claim 14, wherein the instructions, when executed by the at least one processor, further cause the at least one processor to:
receive the transaction record from a processing network computing device; and
store the transaction record in the data structure, prior to matching the response to the transaction record.

20. The non-transitory computer readable storage media of claim 14, wherein the at least one processor is included as part of a processing network; and
wherein the instructions, when executed by the at least one processor, cause the at least one processor to: publish the assigned location within the processing network.
